(19) United States
(12) Patent Application Publication
(10) Pub. No.: US 2019/0070517 A1
(43) Pub. Date: Mar. 7, 2019

(54) Digitally-Interactive Toy System and Method

(71) Applicant: CREATA (USA) INC., Oak Brook Terrace, IL (US)

(72) Inventor: Armando X. Zuniga, Lombard, IL (US)

(21) Appl. No.: 16/122,207

(22) Filed: Sep. 5, 2018

Related U.S. Application Data
(60) Provisional application No. 62/554,478, filed on Sep. 5, 2017.

(51) Int. Cl. A63H 3/28; G06F 3/16

(52) U.S. Cl. CPC A63H 3/28; A63H 3/006; A63H 2200/00; G06F 3/167

(57) ABSTRACT

An interactive toy system and associated methodology provides entertaining stimuli based on real time audio content input sourced to a series of toys from an entertainment provider. The interactive toy system may be said to include a series of toy figures usable in combination with an audio-visual apparatus or device. The toy figures each include an ornamental housing and internal circuitry. The internal circuitry include a microphone for detecting audio input and software to govern certain computer functionality including audio file trigger identification, comparison, matching and audio file selection and delivery for playback at the toy figure in synchrony with the audio content sourced from the entertainment programming. The consumer may thus consume the entertainment programming while the toy figures simultaneously sing along in unison with certain audio content provided during the entertainment program. The toy figures may include animation to enhance the entertainment experience.

### PRIOR HISTORY

This application claims the benefit of pending U.S. Provisional Patent Application No. 62/554,478 filed in the United States Patent and Trademark Office on 5 Sep. 2017.

### BACKGROUND OF THE INVENTION

### Field of the Invention

The present invention relates, in general, to interactive toys and components in an interactive toy system. More particularly, the present invention relates to an animated and audible toy figure, digitally-controlled by input audio content such that the toy figures according to the present invention play back audio content in synchrony with incoming audio content.

### Prior Art Discussion

United States Patent Application Publication No. 2005/0148279 ('279 Publication), authored by Maa, discloses an animated talking toy figure feasible for digital actuation control and synchronization. The toy figure of the '279 Publication has at least one articulated movable portion for providing an animation effect, with the actuation thereof being provided by a two-phase actuation device, such as a solenoid, disposed therein. The toy figure's actuation-control circuitry includes logic switch means, and is adapted to be digitally controlled by a computing device.

A computer-implemented method for controlling and synchronizing the toy figure's sound and animation includes, (i) creating actuation-control signal based on detailed textual content of the toy figure's audio speech, and (ii) synchronously transmitting to the toy figure the actuation-control signal, for control of the actuation-control circuitry, and a sound signal for playback through the toy figure's audio output device.

United States Patent Application Publication No. 2010/0058065 ('065 Publication), authored by Celik et al., discloses certain methodology for extracting and embedding auxiliary data from and to a host signal. In an embodiment, the auxiliary data relates to remote control of an application or a device, such as a digitally interactive toy. Auxiliary data are extracted from a host signal, by periodically searching a first section of the host signal for a first watermark; and, upon detection of the first watermark, searching the host signal for a second watermark. In certain embodiments, information relating to timing and type of action to be performed by a remotely controlled device may be conveyed by the watermarks.

United States Patent Application Publication No. 2012/0271638 ('638 Publication), authored by Regler, discloses certain interactive toys and methods of synchronizing their operation. The '638 Publication describes audio tracks for interactive reproduction at a remote toy encoded with a sub-audible tone or code that uniquely identifies the track with audible output and/or functional operation of the toy. Detection of the sub-audible tone at the interactive toy opens the audio path and permits related motor control in the toy, whereas absence of a relevant sub-audible tone disables at least the audio and, preferably, both the toy's speaker and at least one controllable motor.

The sub-audible tone or code is inserted for the duration of activity only and may come into and out of existence as a specific character track (amongst the plurality of individual audio tracks) moves between active and inactive phases. The audio tracks for remote transmission at the toys are assigned to only a first channel of a stereo audio circuit, with a second channel of the stereo circuit assigned to support a context or background track that is produced from speakers of a media player physically separate from the remote toys.

Conventional synchronized transmission of both stereo channels provides a basis for interaction, with synchronicity between the media player and the remote toy maintained by the sub-audible tones. For simultaneous audio activity in multiple toys, a different sub-audible tone is used relative to individual tones or codes used to control audio output and operation of those multiple toys.

United States Patent Application Publication No. 2015/0049873 ('873 Publication), authored by Buller, discloses a Sound-Activated Music Accessory Device. The 873 Publication describes certain improvements in a device that serves to enhance the listening experience by providing an interaction device. The device can be an item that is seen in the movie or music video and can be included with the CD/DVD or can be sold as a separate item.

The activation and or deactivation are synchronized with the embedded sound that is placed into the soundtrack. The sound, tone, frequency or complex blended sound or sounds are subtle or non-obvious to a person listening to the music but are detected by the accessory device to begin a sequence or stop a sequence to correspond the a particular part of the soundtrack. The activation can mimic what is occurring in a movie, video or soundtrack. The accessory device to be a bracelet, necklace, hat, headband, apparel, plush or rigid toy.

The '873 Publication particularly specifies that its system operates based upon subsonic audio triggers that are embedded into the audio soundtrack at an audio range from 20 Hz to 20K Hz. The prior art thus perceives a need for a system operating off of a proprietary algorithm that analyzes sound or audio content that has been previously acoustically fingerprinted in the audible range for humans in the relatively narrow frequency window of 19 Hz to 31 Hz for enhanced accuracy of the system as discussed in more detail hereinafter.

### SUMMARY OF THE INVENTION

The present disclosure relates to a hardware and software technology platform that allows a full range of interactivity between the physical world (products) and the digital world (content) via sound using acoustic fingerprinting developed under the brand HIJINIX ALIVE™. The HIJINX ALIVE™ platform provides an exemplary device equipped with a system comprising a hardware platform with microphone and software package. Central to the practice of the software package according to the present invention is an acoustic fingerprint algorithm that listens to and identifies audible content. The identified content is then used as a “switch” or trigger to activate sound, light and motion features and functions within the device itself.

The present invention thus basically provides an interactive toy system and associated methodology providing consumers with perceptible stimuli based on real time audio content input. The interactive toy system according to the present invention preferably comprises, in combination an audio-visual apparatus and at least one, but preferably a plurality of toy assemblies that interact with content delivered or sourced to consumers via the audio-visual apparatus. The audio-visual apparatus necessarily comprising certain means for providing audio content output/input.

The toy assembly preferably comprises an externally ornamental visually perceptible housing and internal circuitry. The internal circuitry comprises certain means for detecting audio input such as a microphone. The internal circuitry further employs certain means for identifying audio file triggers associated with the audio content input; certain means for comparing the audio file triggers against an audio file library; and certain means for sourcing a select audio file to the toy assembly governed by a software application that governs the aforesaid functionality.

Further, the internal circuitry comprises certain means for audio file playback. The audio file playback is preferably in synchrony with the audio content input for providing a user with perceptible aural stimuli from the toy assembly while simultaneously providing the ornamental visually perceptible housing for enhancing a user experience with the toy assembly as the user consumes content sourced via the audio-visual apparatus. The interactive toy system and method according to the present invention may further provide certain means for animating the toy assembly for providing toy assembly animation, which toy assembly animation is preferably synchronized with the select audio file and audio content input.

The audio content input is preferably detected at the toy assembly via an audio content-letting aperture formed in the ornamental visually perceptible housing. The audio content-letting aperture is preferably formed in the ornamental visually perceptible housing at an upper portion thereof for providing unobstructed path for the audio content input. The audio content-letting aperture preferably comprises a U-shape having an open end, a rounded closed end, and beveled upper edging, the rounded closed end overlying the means for detecting audio input, the open end and beveled edging for providing a funneling effect for incoming audio content for enhancing audio signal detection via said means for detecting audio input.

The reader is invited to consider certain key points as enumerated below as the reader further considers the more detailed specifications that follow. HIJINX ALIVE™ technology provides a hardware and software platform that allows interactivity between the physical world (products) and the digital world (content). The technology is unique and different because it consists of a proprietary hardware and software platform that uses custom acoustic fingerprinting algorithms to listen for “fingerprinted” sounds (content) which act as triggers to activate the product line.

Other key aspects of the HIJINX ALIVE™ technology according to the present invention include interoperability regardless of content platform (over the air radio, TV, streaming content, mobile devices, apps, etc. . . . ). There is no requirement to modify the activation content; the HIJINX ALIVE™ platform is a standalone system. Further, there is no Bluetooth, no NFC (Near Field Communication), and no Wi-Fi needed.

### BRIEF DESCRIPTION OF THE DRAWINGS

FIG. 1 is a general schematic depiction of the acoustic fingerprinting activation workflow process according to the present invention exemplified between a state of the art content provider and a consumer product toy figure configured to cooperate with incoming digital content.

FIG. 2 is a first toy-based schematic depiction of the digitally interactive system showing a visual display of a generic audio visual apparatus exemplified by a television capable of providing both visual content and audio content with audio output being delivered to a toy assembly as audio content input.

FIG. 3 is a second toy-based schematic depiction of the digitally interactive system showing a visual display of a generic audio visual apparatus exemplified by a television capable of providing both visual content and audio content with audio output being delivered to a toy assembly as audio content input, the toy assembly being optionally in communication with a computing environment.

FIG. 4 is a side-by-side depiction of two generic toy assemblies wherein the left-hand toy assembly is outputting audio content and the right-hand toy assembly is receiving the output audio content as audio content input for triggering functionality of the right-hand toy assembly.

FIG. 5 is an enlarged depiction of a generic toy assembly according to the present invention having an outer toy housing and internal circuitry for cooperating with incoming audio content for triggering functionality of the toy assembly.

FIG. 6 is an enlarged plan view of an audio content input-letting aperture integrated into the toy housing according to the present invention with a microphone device situated in adjacency thereto for detecting incoming audio content.

FIG. 7 is an enlarged sectional view of an audio content input-letting aperture integrated into the toy housing according to the present invention with a microphone device situated in adjacency thereto for detecting incoming audio content.

FIG. 8 is a rough schematic depiction of the primary circuitry features according to the present invention including a certain audio content detection means in the form of a transducer symbol, a software application in the form of a first basic box symbol, certain audio content provision means in the form of a loudspeaker symbol, and certain animation means in the form of a second basic box symbol.

FIG. 9 is circuit diagramming according to the present invention which diagramming provides the reader with a more detailed understanding of the circuitry supporting the operational systemic and methodological features according to the present invention.

FIG. 10 is a first spectrogram of select audio content showing a visual representation of the spectrum of frequencies of sound as they vary with time.

FIG. 11 is a second spectrogram of the select audio content otherwise depicted in FIG. 10 again showing a visual representation of the spectrum of frequencies of sound as they vary with time and outfitted with trigger points derived from a custom algorithm executable by the non-transitory, computer-implementable software application according to the present invention.

FIG. 12 is a third spectrogram of the select audio content otherwise depicted in FIGS. 10 and 11 again showing a visual representation of the spectrum of frequencies of sound as they vary with time and outfitted with select frequency-paired trigger points derived from a custom algorithm executable by the non-transitory, computer-implementable software application according to the present invention.

### DETAILED DESCRIPTIONS OF THE PREFERRED EMBODIMENTS AND METHODOLOGY

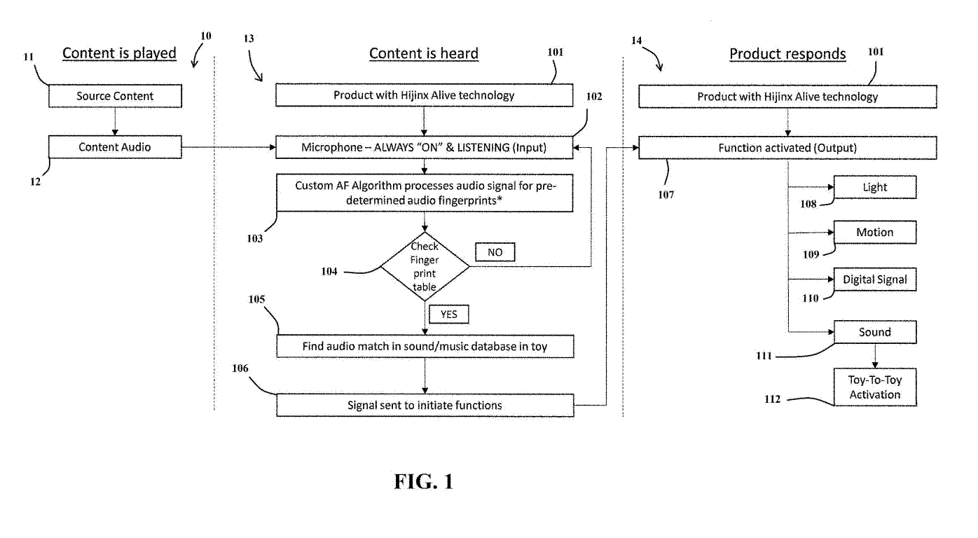

Referring now the drawings with more specificity, the present invention basically relates to a line of retail toy products being developed under the brand HIJINX ALIVE™. In a first iteration, the retail toy products according to the present invention are designed to interact with the BEAT BUGS™ animation series distributed on the NETFLIX™ brand online streaming content provider. For purposes of these specifications, however, a generic toy bear or FIG. 15 is depicted to show how the HIJINIX ALIVE™ system may be made operable with any series of toy assemblies or figures. Referencing FIG. 1 the reader will there consider a general schematic depiction of the application workflow process according to the present invention.

The schematic or flowchart diagram of FIG. 1 attempts to depict a three-tiered system whereby a state of the art content provider is depicted at tier 10. The BEAT BUGS™ animation or character series as distributed by the NETFLIX™ brand online streaming content provider may be considered an exemplary content source as at 11. The primary content sourced by content source 11 as at tier 10 is audio content as at 12. The second tier is generally depicted and referenced at tier 13, at which tier 13 the audio content 12 is heard or detected and analyzed by the toy product line outfitted with the HIJINIX ALIVE™ technology according to the present invention. The third tier is depicted and referenced at tier 14, at which tier 14 the toy product line responds to the detected/analyzed audio content 12 with certain functionality.

As prefaced above, the product line figures are each preferably outfitted with the HIJINIX ALIVE™ technology according to the present invention as at flowchart boxes 101. Audio content 12 is heard or detected and analyzed under tier 13 via a microphone mechanism as at 29 and otherwise depicted at transducer symbol 19 incorporated within the internal circuitry of each figure exemplified by the generic toy bear 15. The microphone is in a perpetually “on” state as at flowchart box 102 for listening or detecting audio content 12 from tier 10.

A custom designed algorithm (as at flowchart box 103) made operable via the non-transitory computer-implementable software application according to the present invention processes the audio content input 12 for pre-determined fingerprints or signatures or triggers 100 by comparing the audio content 12 against a database and querying whether the triggers 100 output by the custom algorithm denote an audio file match from an audio file library 21 as at flowchart query diamond 104.

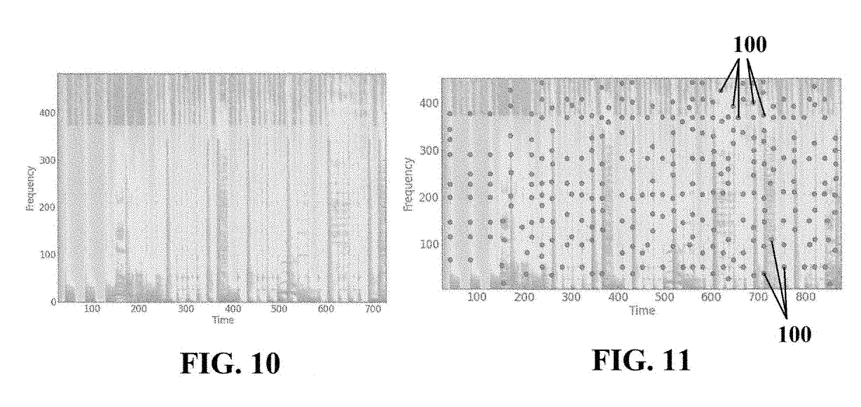

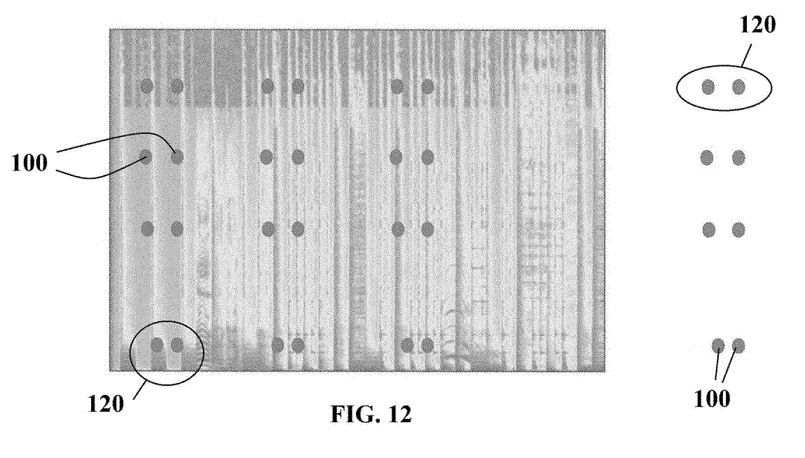

Comparatively referencing FIGS. 10-12, the reader will there note a spectrogram of select audio content 12. FIG. 11 depicts a host of audio content-identifying triggers 100. Comparison of the triggers 100 made operable via the proprietary algorithm according to the present invention may include a select number of triggers as depicted in FIG. 12. Considering FIG. 12, the reader will there note that select frequency-paired triggers 120 as a function of time may preferably be utilized by the algorithm to characterize and identify the audio content 12 for audio content matching against the audio file library 21 and for accurate and synchronized audio file playback 23.

If the query step 104 is negative and the triggers 100 do not operate to find a match in the audio file library 21, the methodology continues to monitor incoming audio content for function-prompting audio content 12. If the query step 104 is positive, the HIJINIX ALIVE™ technology according to the present invention searches for and locates an audio file match from an audio file library 21 (as at flowchart box 105) either (a) housed within the figure exemplified by the generic toy bear 15 or (b) from external sources such as the Internet/cloud or other computing environment 22, and a signal is then sent (as at flowchart box 106) to the product line FIG. 15 for activating figure functionality according to the present invention as at flowchart box 107 within tier 14. The product line functions may include illumination as at flowchart box 108, motion or animation as at flowchart box 109, digital signaling as at flowchart box 110, and audio playback as at flowchart box 111. Each toy FIG. 15 within a series of toy FIG. 15 may operate to trigger other toy FIG. 15 within the series as at flowchart box 112 when audio playback 23 by each FIG. 15 serves as function-prompting audio content 12.

As prefaced above, a generic product line is depicted by the toy bear FIG. 15. In this regard, it is contemplated that the system according to the present invention may be outfitted upon any number of fanciful toy figures so long as the HIJINX ALIVE™ technology is incorporated into the toys and the toys are able to respond to the detected/analyzed audio content 12 in the manner prefaced above and specified in more detail hereinafter. In other words, the toy bear 15 as depicted in the drawings submitted in support of these specifications is meant to depict a generic toy figure or product line according to the present invention and is not meant to be limiting to the character series known as the BEAT BUGS™ animation or character series generally depicted in U.S. Provisional Patent Application No. 62/554,478 the specifications of which are hereby incorporated by reference thereto, and from which these specifications claim a benefit.

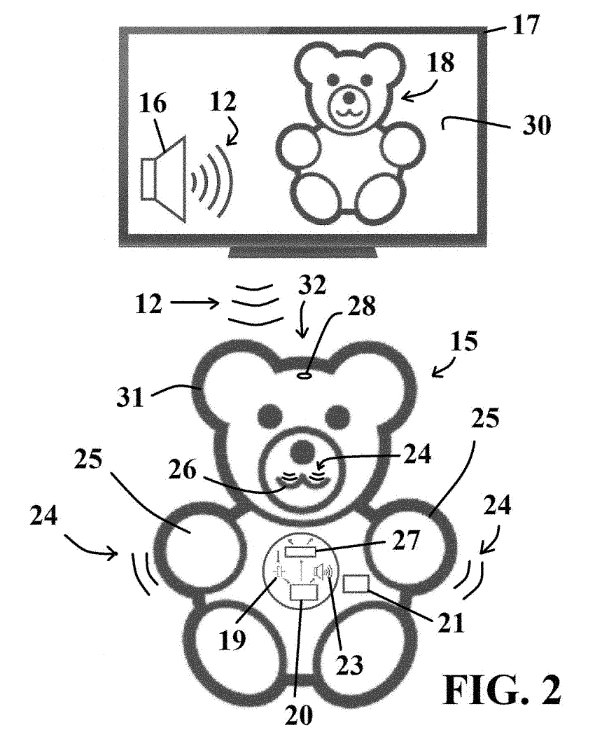

Comparatively referencing FIG. 1 and FIG. 2 the reader will there consider audio content 12. Audio content 12 is first delivered or transmitted to the product line exemplified by toy bear 15 by way of a speaker system 16 preferably associated with an audio-visual device exemplified by a generic television device or apparatus 17. Other types of audio-visual devices may include, but not be limited by tablet computers, smart phones, laptop computers and/or desktop computers outfitted with audio speaker systems as at 16, and visual displays as at 30. So long as the generic device 17 of the interactive system provides both audio content delivery means exemplified by speakers 16, and visual display means exemplified by a visual display 30, the generic device 17 is believed practiced according to the precepts of the present invention.

The product line according to the present invention as exemplified by toy bear 15 is configured to cooperate with incoming audio content 12 preferably delivered thereto from an audio content provider in the form of digital content and converted by the toy assembly or product line figure as at toy bear 15 into digital content for digitally-based playback 23. In this configuration, the HIJINX ALIVE™ technology uses a custom acoustic fingerprinting algorithm to listen to the audio content 12 and the toy product line then identifies previously fingerprinted or signatures within the audio segments of episodes sourced to the consumer via the apparatus or device 17.

The product line or toy figures as at toy bear 15 utilize the acoustic signatures or fingerprints as triggers 100 to instruct the toy FIG. 15 to sing along, light up via one or more external illumination elements (not specifically illustrated), and/or move their mouths 26 in synchronization with the audio playback 23. The acoustic signatures or fingerprints according to the present invention derive from a custom-designed algorithm and a number of novel optimizations to provide reliable operation on figure devices outfitted with relatively low central processing capacity.

The implementation according to the present invention is designed for low-power chipsets with a (relatively) small trigger target library, and as such is believed to use a unique approach in comparison to traditional fingerprinting implementations. Low-power chipsets and off-the shelf development boards are preferably used for the acoustic fingerprint development according to the present invention. Excellent results have been obtained using the Nuvoton M0, M4, M7, and M4 chipset(s). Such exemplary chipsets such as these are preferred for production due to the relatively low cost, on board Digital Signal Processor (DSP), and the ready commercial availability thereof in the market. Besides ensuring that each trigger 100 is detected reliably, the second most critical factor associated with the proprietary algorithm according to the present invention is to reduce any latency between the trigger points 100 and the device playback 23. The proprietary algorithm is purposefully designed with timing synchronization in mind, and has resulted in negligible synchronization delay.

The toy figures or assemblies 15 according to the present invention may be preferably further configured to digitally interact with mobile software applications exemplified by the BEAT BUGS™ mobile application or “app” using the same technology platform. The BEAT BUGS™ app is available in both Apple and Android formats and is free to consumers. The BEAT BUGS™ app can be downloaded to mobile devices from the software stores exemplified by the APPLE® App Store and the GOGGLE® Play Store.

In view of the foregoing, the reader will further consider that the present invention contemplates an interactive toy-based system and method whereby the interactive toy system and associated methodology provides a user with toy product line that may be synchronized both visually and aurally based on real time digital audio content input 12. In an exemplary embodiment, incoming audio data or content 12 may be provided via a streaming service provider exemplified by the NETFLIX™ brand online streaming content provider.

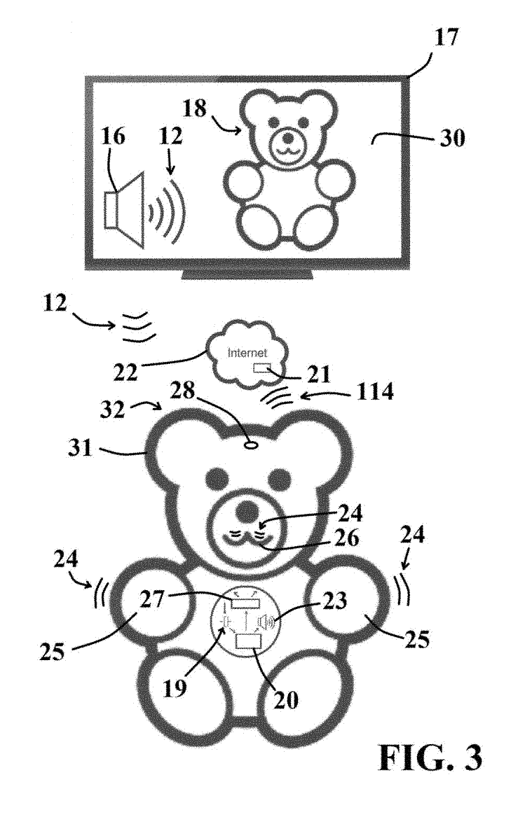

Audio data or content 12 may be provided by the streaming service provider via an audio playback apparatus or device as exemplified by generic television 17. The playback audio content source may be catalogued and housed in an audio file library 21 either stored within the toy product line figures as generally depicted in FIG. 2 or accessed via the Internet or similar external source as generally depicted in FIG. 3. Select audio files may then be retrieved form the audio file library 21 on an as needed basis by the interactive toy system according to the present invention.

The interactive system is preferably toy-based and in this regard necessarily depends upon a toy assembly comprising an externally ornamental fanciful or amusing visually perceptible housing generically depicted by toy bear FIG. 15. Comparatively referencing the various figures, the reader will note that the figures generically depicted by toy bear FIG. 15 preferably comprises an external housing 31 that resembles or mimics the visual appearance of the characters otherwise visually displayed upon the apparatus 17 as at the visually displayed toy bear character 18 displayed upon the apparatus 17 in FIGS. 2 and 3.

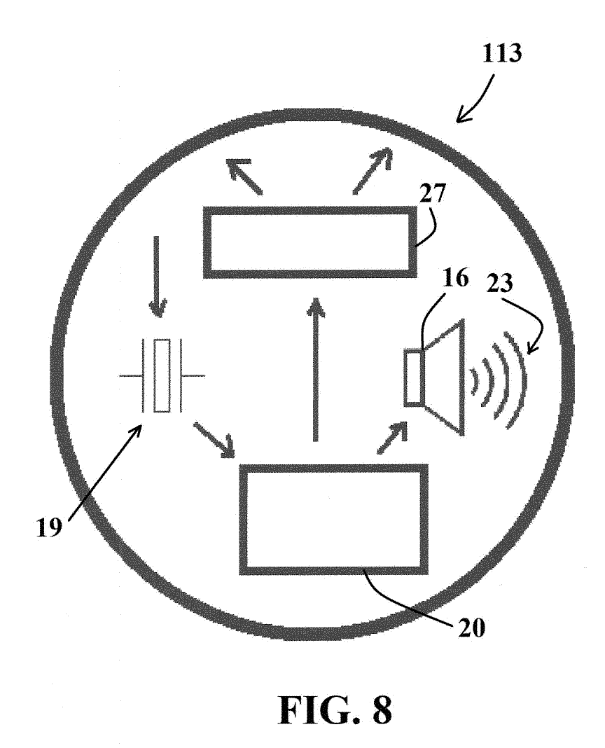

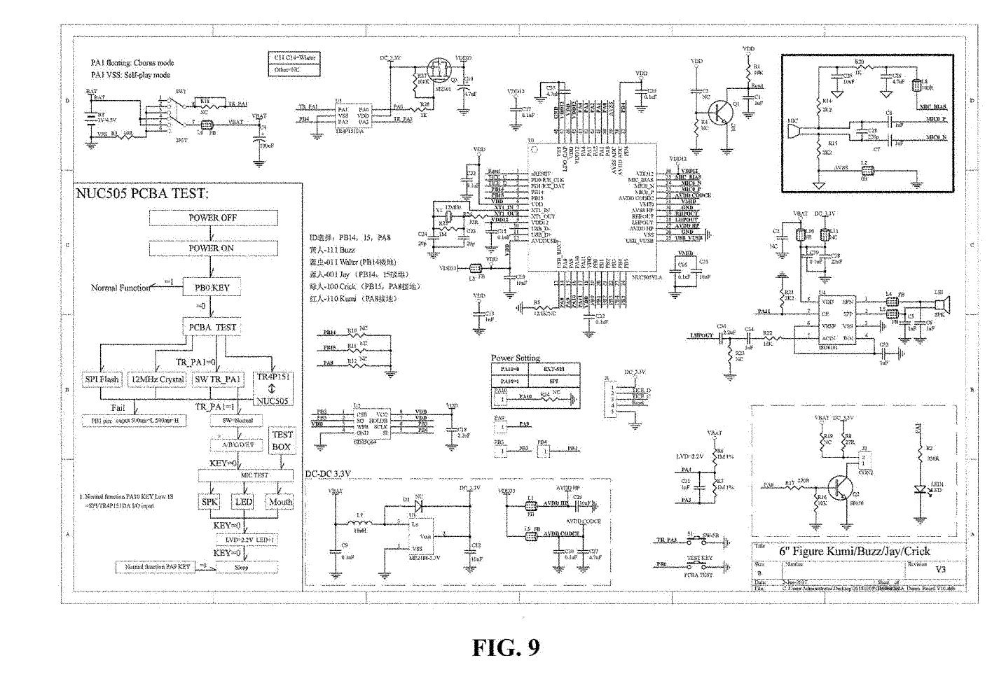

Further referencing FIGS. 2 and 3, the visually displayed characters as at the toy bear character 18 provide an exemplary externally ornamental, fanciful or amusing visual appearance. The toy assemblies or figures according to the product line of the present invention may thus comprise (a) certain externally ornamental, fanciful or amusing visual housing that mimic or resemble the visually displayed character(s) 18 as well as (b) certain internal circuitry as detailed roughly in FIG. 8 and more specifically diagrammed in FIG. 9. Referencing FIG. 8 the reader will there consider the basic internal circuitry as at schematic 113.

The basic internal circuitry preferably comprises certain means for detecting audio content or input 12 as generically depicted at transducer symbol 19 or via a microphone mechanism 29. Audio content or input 12 is typically provided by way an audio output from an audio-visual playback apparatus or device exemplified by a television apparatus as generically referenced at 17. Loudspeakers as at speaker symbol 16 associated with the apparatus 17 may deliver or provide aurally perceptible audio content 12 from a digitally-based source. An audio file is generically depicted as an audio output/input content 12, which audio content 12 is depicted to convey audio content otherwise delivered in the form of sound energy.

The audio content 12 of an audio file may preferably comprise audio file signatures or fingerprints associated therewith and the present system and method contemplates certain means for identifying the audio file signatures or fingerprints for any given audio file or audio content 12 with audio file analysis means based upon a proprietary algorithm governing or implemented by way of a non-transitory computer-implementable software application as generically depicted at box 20. The audio file signatures or fingerprints are then compared against an audio file library 21 either housed on board the toy assembly or figure as at toy bear 15 or accessible via external sources as generically represented by an Internet/cloud symbol 22 for denoting an external computing environment in communication (as at 114) with the toy assembly of FIG. 15.

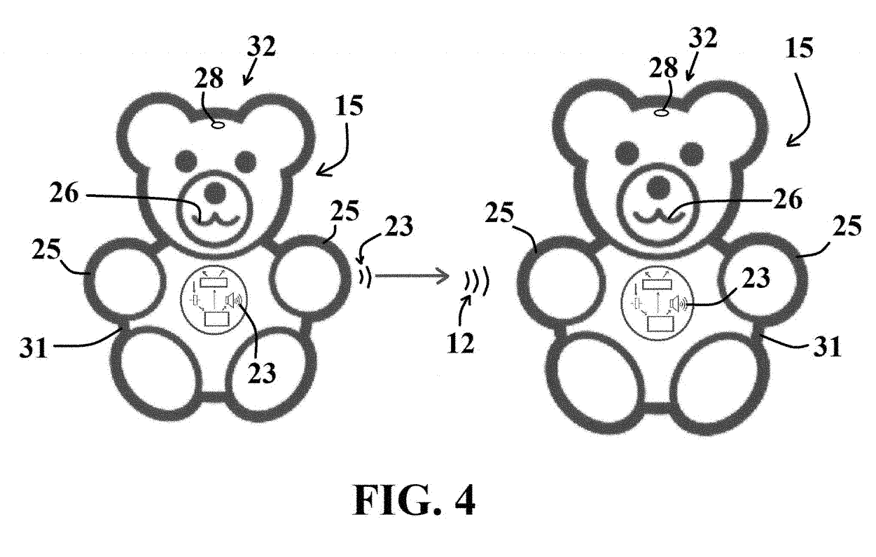

The audio content 12 is thus compared against the audio file library 21 via certain audio file signature or fingerprint comparison means governed or controlled by the software application 20. A select audio playback file may then be selected or sourced from the audio file library 21 whereafter certain means for synchronizing the audio content 12 with the select audio playback file from the audio file library 21 operate to synchronize audio file playback as at 23 with the audio content 12 as the content is delivered to the toy assembly or FIG. 15 in real time. Audio file playback 23 from a first FIG. 15 may also serve as audio content 12 for other FIG. 15 positioned in proximity to the first FIG. 15 as generally depicted in FIG. 4.

The means for audio file playback are operable to playback the select audio playback file in a synchronized manner with the audio content 12. The select audio playback file provides the user with perceptible aural stimuli as at playback 23 while simultaneously providing the amusing visually perceptible appearance of the toy assembly or FIG. 15 for enhancing the user's experience with the toy assembly or FIG. 15 as the user may simultaneously consume content provided upon the apparatus or device 17.

The interactive toy system and associated methodology may further preferably comprise certain animation means for animating the toy assembly or FIG. 15 for providing toy assembly animation as generically depicted and referenced at animation lines 24. Most typically, toy arms 25 and a toy mouth 26 may be animated by way of internal mechanism not specifically illustrated in the drawings submitted in support of these specifications, but governed according to state of the art animation means as generically depicted at box 27 as controlled by the software application 20 and internal circuitry necessarily comprising a power source. The audio content 12 operates to switch on or trigger the playback 23, animation 24 or illumination of optional illumination elements (not specifically illustrated).

The toy assembly animation 24 may further be preferably synchronized with the select audio file playback 23 such that arm 25 and mouth 26 animation 24 may correspond with the audio content 12. In a preferred embodiment, the toy assembly animation 24 may further correspond with content conveyed via the audio content 12 whereby the toy assembly or FIG. 15 may mimic movements of character(s) 18 otherwise visually displayed upon the audio-visual apparatus 17 generically depicted by television.

Stated methodologically, the present invention may be said to provide a toy-based method for providing synchronized, perceptible stimuli based on real time digital audio content input 12. The toy-based method according to the present invention may be said to comprise the initial step of providing a toy assembly of figure as at 15, which toy assembly or FIG. 15 preferably comprises an externally ornamental fanciful or amusing visually perceptible housing and certain internal circuitry.

The toy assembly or FIG. 15 may thus detect audio content input 12 via the internal circuitry via certain means for detecting audio input such as a microphone generically depicted by a transducer 19. Audio file signatures or fingerprints may then be identified that are associated with the audio content input 12 via certain audio file fingerprint identification means made part of the computer-driven software application 20 according to the present invention, which application 20 controls or governs the methodology and is thus central to the practice of the present invention.

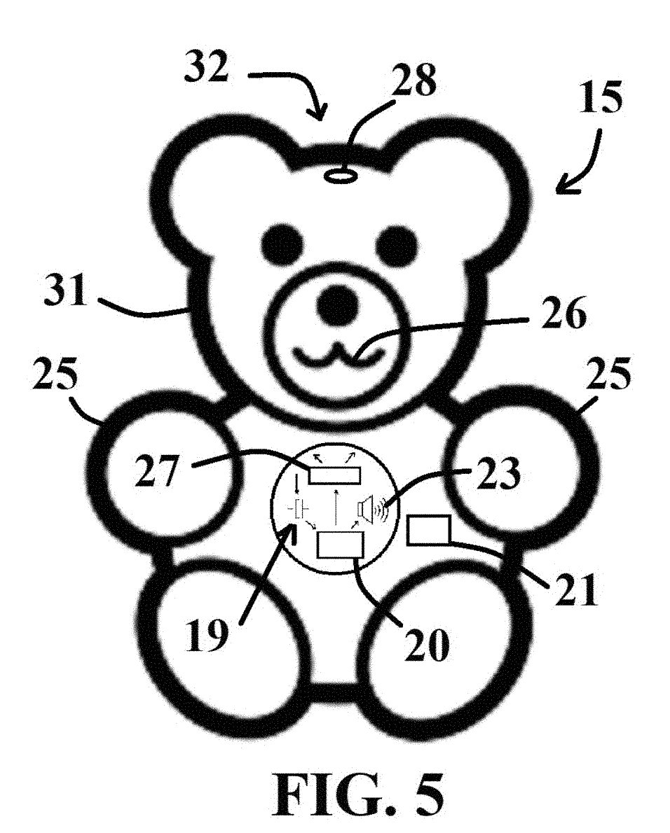

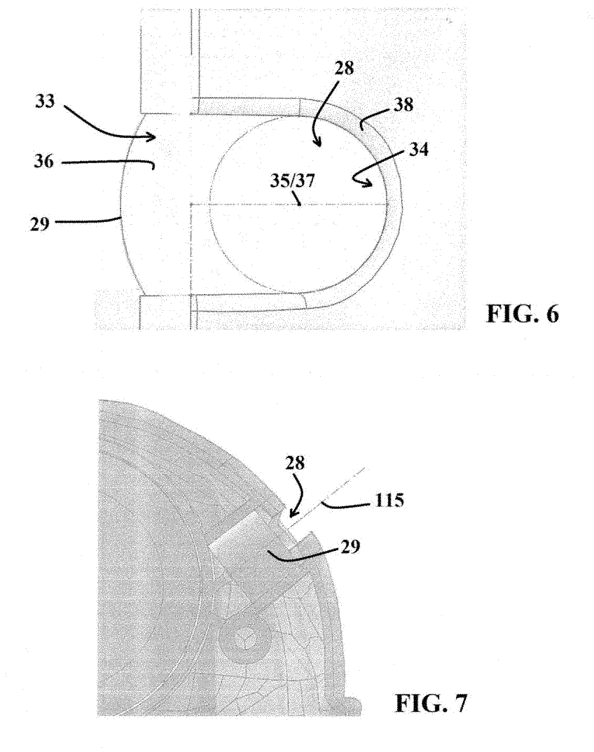

The microphone 29 is preferably housed within the toy assembly or FIG. 15 adjacent an audio content-letting aperture 28 preferably formed at an upper portion 32 of the toy assembly or FIG. 15 as generally depicted in FIGS. 2-7. The audio content-letting aperture 28 is preferably sized and shaped to be inconspicuous visually. The audio content-letting aperture 28 is preferably positioned at an upper portion 32 of the toy assembly or FIG. 15 so as to be optimally placed to provide for a more direct, unobstructed audio content-receiving path from either the content source provider or other FIG. 15 situated in proximity to the microphone 29.

The audio content-letting aperture 28 may preferably comprise a U-shape having an open end as at 33, a rounded closed end as at 34, and beveled or radiused edging as at 38. The rounded closed end 34 may overlie the microphone 29 such that a center 35 of an upper portion 36 of the microphone 29 is collinear (as at axis 115) with the radiused center 37 of the closed end 34. The open end 33 and edging 38 provide a funneling effect for incoming audio content 12 and are thus believed to enhance audio signal detection at the underlying microphone 29.

The audio file signatures or fingerprints are compared against an audio file library 21 via certain audio file fingerprint comparison means and a select audio file from the audio file library 21 is sourced to the toy assembly or FIG. 15 via certain audio file sourcing means. The sourced select audio file is preferably synchronized with the incoming audio content input 12 via certain audio file synchronization means exemplified by the software application 20.

The synchronized select audio file is then played back as at 23 via certain audio file playback means typically by way of a certain loudspeaker mechanism 16 housed within the toy assembly or FIG. 15. The select audio file playback 23 thereby provides a user with perceptible aural stimuli while simultaneously providing the amusing visually perceptible appearance for enhancing a user experience with the toy assembly or FIG. 15 while the user may simultaneously consume content upon the apparatus or device 17 as sourced thereto from a content provider.

What is claimed is:

1. An interactive toy system, the interactive toy system for providing entertaining stimuli based on real time audio content input, the interactive toy system comprising, in combination:
an audio-visual apparatus, the audio-visual apparatus comprising means for providing the audio content input; and
at least one toy assembly, each toy assembly comprising an externally ornamental housing and internal circuitry, the internal circuitry comprising means for detecting audio input, means for identifying audio file triggers associated with the audio content input, means for comparing the audio file triggers against an audio file library, means for sourcing a select audio file to the toy assembly, and means for audio file playback, the means for audio file playback being operable to playback the select audio file in synchrony with the audio content input, playback of the select audio file in synchrony with the audio content input thereby providing a user with entertaining aural stimuli from the toy assembly while simultaneously providing the ornamental housing for enhancing a user experience with the toy assembly as the user consumes content sourced via the audio-visual apparatus.

2. The interactive toy system of claim 1 wherein the at least one toy assembly comprises means for animating the at least one toy assembly for providing toy assembly animation.

3. The interactive toy system of claim 2 wherein the toy assembly animation is synchronized with the select audio file and audio content input.

4. The interactive toy system of claim 1 wherein the audio content input is detected at the at least one toy assembly via an audio content-letting aperture formed in the ornamental housing.

5. The interactive toy system of claim 4 wherein the audio content-letting aperture is formed in the ornamental visually perceptible housing at an upper portion thereof for providing unobstructed path for the audio content input.

6. The interactive toy system of claim 5 wherein the audio content-letting aperture comprises a U-shape having an open end, a rounded closed end, and beveled upper edging, the rounded closed end overlying the means for detecting audio input, the open end and beveled edging for providing a funneling effect for incoming audio content input for enhancing audio signal detection via said means for detecting audio input.

7. The interactive toy system of claim 1 wherein the audio file triggers are frequency paired as a function of time from a spectrogram of the audio content input.

8. The interactive toy system of claim 1 wherein the audio-visual apparatus comprises a visual display, the visual display for displaying imagery reflective of the ornamental housing, the imagery and select audio file playback together enhancing the user experience with the at least one toy assembly.

9. An interactive toy system, the interactive toy system for providing entertaining stimuli based on real time audio content input, the interactive toy system comprising:
a toy assembly, the toy assembly comprising an externally ornamental housing and internal circuitry, the internal circuitry comprising means for detecting audio input, means for identifying an audio file triggers associated with the audio content input, means for comparing the audio file triggers against an audio file library, means for sourcing a select audio file to the toy assembly, and means for audio file playback, the means for audio file playback being operable to playback the select audio file in synchrony with the audio content input, playback of the select audio file in synchrony with the audio content input thereby providing a user with entertaining aural stimuli from the toy assembly while simultaneously providing the ornamental housing for enhancing a user experience with the toy assembly.

10. The interactive toy system of claim 9 wherein the toy assembly comprises means for animating the toy assembly for providing toy assembly animation.

11. The interactive toy system of claim 9 wherein the audio content input is detected at the toy assembly via an audio content-letting aperture formed in the ornamental housing.

12. The interactive toy system of claim 11 wherein the audio content-letting aperture is formed in the ornamental housing at an upper portion thereof for providing unobstructed path for the audio content input.

13. The interactive toy system of claim 12 wherein the audio content-letting aperture comprises a U-shape having an open end, a rounded closed end, and beveled upper edging, the rounded closed end overlying the means for detecting audio input, the open end and beveled edging for providing a funneling effect for incoming audio content for enhancing audio signal detection via said means for detecting audio input.

14. The interactive toy system of claim 9 wherein the audio file triggers are frequency paired as a function of time from a spectrogram of the audio content input.

15. The interactive toy system of claim 9 usable in combination with a visual display, the visual display for displaying imagery reflective of the ornamental housing, the imagery and select audio file playback together enhancing the user experience with the toy assembly.

16. A toy-based method for providing entertaining stimuli based on real time audio content input, the toy-based method comprising the steps of:
providing a toy assembly, the toy assembly comprising an externally ornamental housing and internal circuitry;
detecting audio content input via the internal circuitry;
identifying select audio file triggers associated with the audio content input via audio file trigger identification means;
comparing the select audio file triggers against an audio file library via audio file trigger comparison means;
sourcing a select audio file from the audio file library to the internal circuitry via audio file sourcing means; and
playing back the select audio file in synchrony with the audio content input via audio file playback means via the internal circuitry, the playback of the select audio file thereby providing a user with entertaining aural stimuli while simultaneously providing the ornamental housing for enhancing a user experience with the toy assembly.

17. The toy-based method of claim 16 comprising the step of animating the toy assembly via toy assembly animation means.

18. The toy-based method of claim 17 wherein the toy assembly animation is synchronized with the select audio file and audio content input.

19. The toy-based method of claim 16 wherein the audio file triggers are frequency paired as a function of time from a spectrogram of the audio content input.

20. The toy-based method of claim 16 wherein the audio content input is detected at the toy assembly via an audio content-letting aperture formed in an upper portion of the ornamental housing, the audio content-letting aperture comprising an open end, a rounded closed end, and beveled upper edging, the open end and beveled edging for providing a funneling effect for incoming audio content for enhancing audio signal detection.
